(19) United States
(12) Patent Application Publication
(10) Pub. No.: US 2022/0171989 A1
(43) Pub. Date: Jun. 2, 2022

(54) INFORMATION THEORY GUIDED SEQUENTIAL REPRESENTATION DISENTANGLEMENT AND DATA GENERATION

(71) Applicant: NEC Laboratories America, Inc., Princeton, NJ (US)

(72) Inventors: Renqiang Min, Princeton, NJ (US); Asim Kadav, Mountain View, CA (US); Hans Peter Graf, South Amboy, NJ (US); Ligong Han, Edison, NJ (US)

(21) Appl. No.: 17/529,622

(22) Filed: Nov. 18, 2021

Related U.S. Application Data
(60) Provisional application No. 63/119,793, filed on Dec. 1, 2020.

(51) Int. Cl. G06K 9/62; G06N 20/00; G10L 15/00; B60W 30/09

(52) U.S. Cl. CPC G06K 9/6232; G06N 20/00; B60W 2420/54; G10L 15/00; B60W 30/09; G06K 9/6215

(57) ABSTRACT

A computer-implemented method for representation disentanglement is provided. The method includes encoding an input vector into an embedding. The method further includes learning, by a hardware processor, disentangled representations of the input vector including a style embedding and a content embedding by performing sample-based mutual information minimization on the embedding under a Wasserstein distance regularization and a Kullback-Leibler (KL) divergence. The method also includes decoding the style and content embeddings to obtain a reconstructed vector.

### RELATED APPLICATION INFORMATION

This application claims priority to U.S. Provisional Patent Application No. 63/119,793, filed on Dec. 1, 2020, incorporated herein by reference in its entirety.

### BACKGROUND

### Technical Field

The present invention relates to audio and video processing and more particularly to information theory guided sequential representation disentanglement and data generation.

### Description of the Related Art

Representation learning is one of the essential research problems in machine learning. The sensory data in the real world, such as video, image, and audio, are usually in the form of high dimensions. Representation learning aims to map these data into a low-dimension space to make it easier to extract useful information for downstream tasks such as classification and detection. Recent years witness a rising interest in disentangled representations, which separates the underlying factors of observed data variation such that each factor exclusively interprets one semantic attributes of sensory data. For instance, a desirable disentanglement of artistic images can separate the style and content information. The representation of sequential data is expected to be disentangled as time-varying factors and time-invariant factors. For video data, the identity of the object is regarded as a time-invariant factor, and the motion in each frame is considered as time-varying factors. In speech data, the representations of the identity of the speaker and the linguist content are expected to be disentangled. There are several benefits of disentangled representation. First, the learned models that produce disentangled representations are more explainable. Second, the disentangled representations make it easier and more efficient to manipulate data generation. Hence, there is a need for an approach to obtaining disentangled representations.

### SUMMARY

According to aspects of the present invention, a computer-implemented method for representation disentanglement is provided. The method includes encoding an input vector into an embedding. The method further includes learning, by a hardware processor, disentangled representations of the input vector including a style embedding and a content embedding by performing sample-based mutual information minimization on the embedding under a Wasserstein distance regularization and a Kullback-Leibler (KL) divergence. The method also includes decoding the style and content embeddings to obtain a reconstructed vector.

According to other aspects of the present invention, a computer program product for representation disentanglement is provided. The computer program product includes a non-transitory computer readable storage medium having program instructions embodied therewith. The program instructions are executable by a computer to cause the computer to perform a method. The method includes encoding, by a hardware processor of the computer, an input vector into an embedding. The method further includes learning, by the hardware processor, disentangled representations of the input vector including a style embedding and a content embedding by performing sample-based mutual information minimization on the embedding under a Wasserstein distance regularization and a Kullback-Leibler (KL) divergence. The method also includes decoding, by the hardware processor, the style and content embeddings to obtain a reconstructed vector.

According to yet other aspects of the present invention, a computer processing system for representation disentanglement is provided. The system includes a memory device for storing program code. The system further includes a processor device, operatively coupled to the memory device, for running the program code to encode an input vector into an embedding. The processor device further runs the program code to learn disentangled representations of the input vector including a style embedding and a content embedding by performing sample-based mutual information minimization on the embedding under a Wasserstein distance regularization and a Kullback-Leibler (KL) divergence. The processor device also runs the program code to decode the style and content embeddings to obtain a reconstructed vector.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary system for information theory guided sequential representation disentanglement and data generation, in accordance with an embodiment of the present invention;

FIG. 3 is a flow diagram showing a method for information theory guided sequential representation disentanglement and data generation, in accordance with an embodiment of the present invention;

FIGS. 4-5 are block diagrams showing an exemplary method for representation disentanglement, in accordance with an embodiment of the present invention; and

FIG. 6 is a block diagram showing an exemplary environment to which the present invention can be applied, in accordance with an embodiment of the present invention.

### DETAILED DESCRIPTION OF PREFERRED EMBODIMENTS

In accordance with embodiments of the present invention, systems and methods are provided for information theory guided sequential representation disentanglement and data generation.

Embodiments of the present invention present a sequential representation disentanglement and data generation framework for videos/audios, based upon the theoretical guidance of information theory. Inspired by variation of information (VI), the present invention introduces an information-theoretical objective to quantitatively measure how well the learned representations are disentangled. Specifically, the inventive model reduces the dependency between static part and dynamic part embeddings by minimizing an innovative sample based mutual information upper bound. Besides, the mutual information between latent embeddings and the input data is meanwhile maximized to ensure the representativeness of the latent embeddings (i.e., style and content embeddings), by minimizing a Wasserstein distance between a generated data distribution and a real data distribution.

Contributions of the inventive framework can be summarized as follows: A principal framework is introduced to learn disentangled representations of videos/audios. By minimizing a novel VI-based disentangled representation learning (DRL) objective, the inventive model not only explicitly reduces the correlation between static part and dynamic part embeddings, but also preserves the sentence information in the latent spaces at the same time. A general sample-based mutual information upper bound is employed to facilitate the minimization of a VI-based objective. With this upper bound, the dependency of static and dynamic embeddings can be decreased effectively and stably.

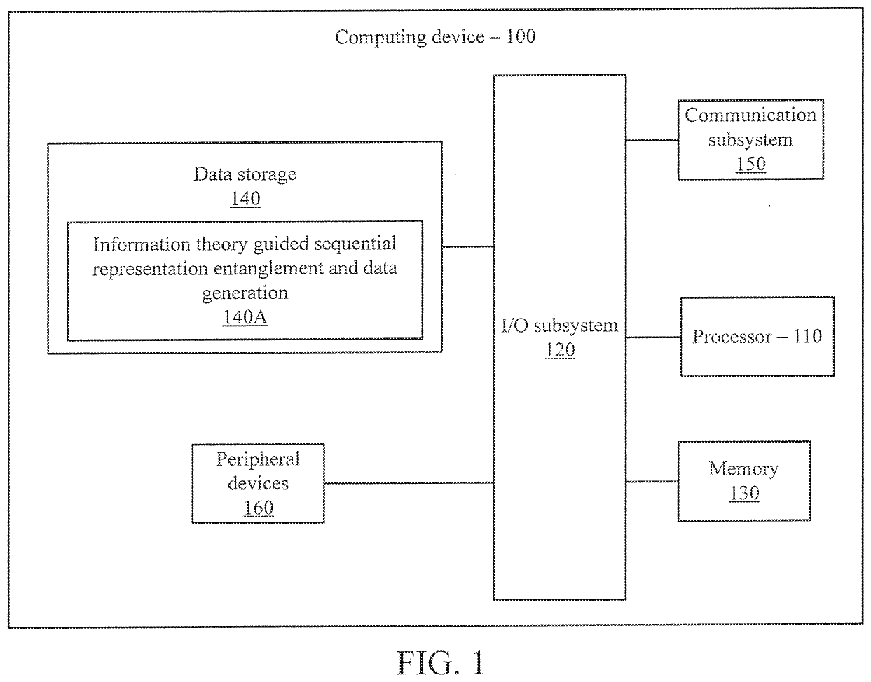

FIG. 1 is a block diagram showing an exemplary computing device 100, in accordance with an embodiment of the present invention. The computing device 100 is configured to perform information theory guided sequential representation disentanglement and data generation.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for information theory guided sequential representation disentanglement and data generation. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

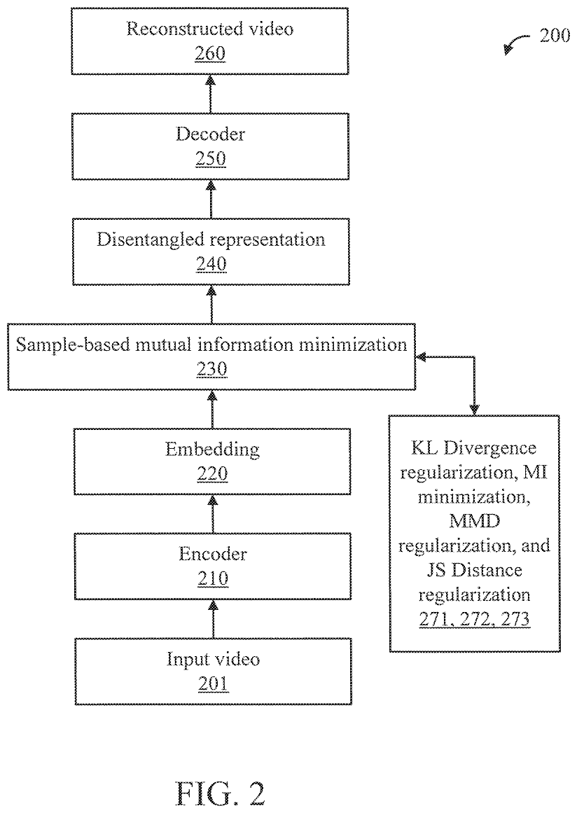

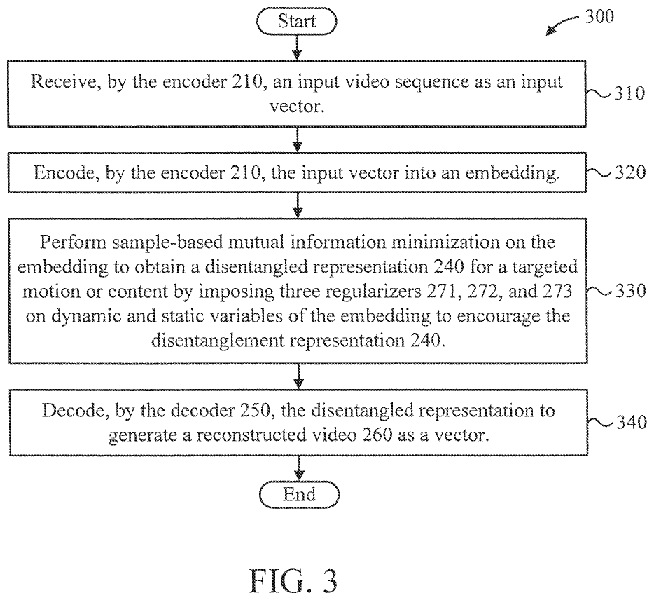

FIG. 2 is a block diagram showing an exemplary system 200 for information theory guided sequential representation disentanglement and data generation, in accordance with an embodiment of the present invention. FIG. 3 is a flow diagram showing a method 300 for information theory guided sequential representation disentanglement and data generation, in accordance with an embodiment of the present invention.

System 200 involves an input video 201, an encoder 210, an embedding 220, sample-based mutual information minimization 230, a disentangled representation 240, a decoder 250, and reconstructed video 260. While an input video 201 is shown, the input in other embodiments can be acoustic, textual, and so forth.

The encoder 210 is an encoder part of an autoencoder model. The encoder part of the autoencoder model translates a vector representation into an embedding in a latent space, and the decoder part translates an embedding in the latent space back into a vector representation.

At block 310, receive, by the encoder 210, an input video sequence as an input vector.

At block 320, encode, by the encoder 210, the input vector into an embedding.

At block 330, perform sample-based mutual information minimization on the embedding to obtain a disentangled representation 240 for a targeted motion or content by imposing three regularizers 271, 272, and 273 on dynamic and static variables of the embedding to encourage the disentanglement representation 240. The three regularizers include (1) a KL Divergence Regularization 271, (2) a mutual information minimization regularizer 272, and (3) a MMD Regularization, and a JS distance regularization 273.

At block 340, decode, by the decoder 250, the disentangled representation to generate a reconstructed video 260 as a vector.

Some notations and the problem definition will now be described. D={Xⁱ}^{M} are given as a dataset that include M i.i.d. sequences, where Z≡x_{1:T}=(x₁, x₂, . . . , x_{T}) denote a sequence of T observed variables, such as a video of T frames or an audio of T segments. Sequential variational encoder models are adopted here. Presume the sequence is generated from latent variable [symbol] . The latent variable [symbol] is factorized into two disentangled factors: a time-invariant variable z_{f}; and the time-varying factor z_{1:T}.

Priors: The prior of [symbol] _{f} is defined as a standard Gaussian distribution: [symbol] _{f}˜ [symbol] (0,1). The time-varying latent variable [symbol] _{1:T} follows a recurrent prior as follows:

[symbol]

ₜ| [symbol] _{<t}˜ [symbol] (μₜ,diag(σₜ²)), (1)

where [μₜ, σₜ]=Ø_{R}^{prior} ( [symbol] _{<t}), μₜ, σₜ are the parameters of the prior distribution conditioned on all previous time-varying latent variable. The model Ø_{R}^{prior} can be parameterized as a recurrent network, such as LSTM or GRU, where the hidden state is updated temporarily. The prior can be factorized as:

p( [symbol] )=p( [symbol] _{f})p( [symbol] _{1:T})=p( [symbol] _{f})Πₜ₌₁^{T}p( [symbol] ₜ| [symbol] _{<t}) (2)

Generation: The generating distribution of time step t is conditioned on [symbol] _{f} and [symbol] ₜ as follows:

xₜ| [symbol] _{f} [symbol] ₜ˜ [symbol] (μ_{x,t},diag(σ_{x,t}²)), (3)

where [μ_{x,t},σ_{x,t}]=Ø^{Decoder} can be a highly flexible function such as neural networks.

The complete generative model can be formalized by factorization:

p(x_{1:T}, [symbol] _{1:T}, [symbol] _{f})=p( [symbol] _{f})Πₜ₌₁^{T}p(xₜ| [symbol] _{f} [symbol] ₜ)p( [symbol] ₜ| [symbol] _{<t}) (4)

Inference: The sequential VAE in accordance with the present invention uses variational inference to learn an approximate posterior q( [symbol] _{f}|x_{1:T}) and q( [symbol] ₜ|x_{≤t}):

[symbol]

_{f}˜ [symbol] (μ_{f},diag(σ_{f}²)), [symbol] ₜ˜ [symbol] (μₜ,diag(σₜ²)), (5)

where [μ_{f},σ_{f}]=ψ_{f}^{Encoder}(x_{1:T}) and [μₜ,σₜ]=ψ_{R}^{Encoder}(x_{≤t}).

The inference model in accordance with the present invention is factorized as follows:

q( [symbol] _{1:T}, [symbol] _{f}|x_{1:T})=q( [symbol] _{f}|x_{1:T})Πₜ₌₁^{T}q( [symbol] ₜ|x_{≤t}) (6)

Learning: The objective function of sequential VAE is a timestep-wise negative variational lower bound:

$${ℒ}_{V AE} = {𝔼}_{q ( {z}_{1 : T} , {z}_{f} \vert {x}_{1 : T} )} [ - {\sum }_{t = 1}^{T} log p ( {x}_{t} \vert {z}_{f} , {z}_{t} ) ] + KL ( q ( {z}_{f} \vert {x}_{1 : T} ) \vert \vert p ( {z}_{f} ) ) + {\sum }_{t = 1}^{T} KL ( q ( {z}_{t} \vert {x}_{\leq t} ) \vert \vert p ( {z}_{t} \vert {z}_{\leq t} ) ) \qquad ( 7 )$$

Note that the model in accordance with the present invention is different from a conventional variational recurrent autoencoder which fails in considering the latent representation disentanglement. Besides, DSVAE assumes the variational posterior of [symbol] _{1:T} depends on [symbol] _{f}, and thus it first infers [symbol] _{f} and then samples [symbol] ₜ conditioned on [symbol] _{f}, which implies the variables are still implicitly entangled. In contrast, here [symbol] _{f} and [symbol] ₜ are inferred totally independently to enforce the representation disentanglement, resulting in a more efficient and concise model.

In the framework of the proposed model in the context of video data: Each frame of the video x_{1:T} is fed into the encoder to produce a sequence of the visual features, which is then passed through the LSTM to obtain the manifold posterior of the dynamic latent variable {q( [symbol] ₜ|x_{≤t})}Tₜ₌₁ and the posterior of the static latent variable q( [symbol] _{f}|x_{1:T}). The static and dynamic representations [symbol] _{f} and [symbol] _{1:T} are sampled, from the corresponding posteriors and concatenated to be fed into the decoder to generate reconstructed sequence x_{1:T}. Three regularizors are imposed on dynamic and static latent variables to encourage the representation disentanglement.

To encourage the time-invariant representation [symbol] _{f} to exclude any dynamic information, it is expected that [symbol] _{f} changes little when dynamic information dramatically varies. Therefore, the mutual information of static and dynamic factors is introduced as a regulator [symbol] _{MI}. The mutual information is a measure of the mutual dependence between two variables. The formal definition is the Kullback-Leibler divergence of the joint distribution to the product of marginal distribution of each variable as follows:

[symbol]

_{MI}( [symbol] _{f}, [symbol] _{1:T})=Σₜ₌₁^{T}KL(q( [symbol] _{f}, [symbol] ₜ)∥q( [symbol] _{f})q( [symbol] ₜ))

By minimizing the mutual information of static factor c with content embedding [symbol] _{f} and dynamic factor m with motion embedding { [symbol] ₜ}, the information in these two factors are encouraged to be mutually exclusive. To disentangle the static and dynamic embeddings, the mutual information between c and m is minimized as I(m; c). Meanwhile, the latent embeddings c and m should sufficiently, respectively, include content information and motion information from videos x. Therefore, I(c; x) and I(m; x) are maximized at the same time. To sum up, the overall disentangled representation learning objective in accordance with an embodiment of the present invention is as follows:

[symbol]

_{Dis}=[I(m;c)−I(x;c)−I(x;m)].

A description will now be given regarding a theoretical justification to the objective, in accordance with an embodiment of the present invention.

The objective [symbol] _{Dis} has a strong connection with the dependence measurement in information theory. Variation of Information (VI) is a well-defined metric of independence between variables. Applying the triangle inequality to m, c and x, the following is obtained:

VI(m;x)+VI(x;c)≥VI(m;c) (8)

The equality reaches if and only if the information from variable x is totally separated into two independent variable m and c, which is an ideal scenario for disentangling sentence x into style embedding s and content embedding c. Therefore, the difference between left-hand side and right-hand side in Equation (8) measures the degree of disentanglement as follows:

D(x;m,c)=VI(m;x)+VI(x;c)−VI(c;m).

By the definition of VI, D(x; s, c) can be simplified to the following:

VI(c;x)+VI(x;m)−VI(m;c)=2H(x)+2[I(m;c)−I(x;c)−I(x;m)].

Since H(x) is a constant derived from data, only I(m; c)−I(x; c)−I(x; m) is minimized, which is exactly the same as the objective [symbol] _{Dis}.

However, minimizing the exact value of mutual information in the objective [symbol] _{Dis} will cause numerical instability, especially when the dimension of latent embeddings is large. Therefore, several MI estimations are introduced herein to effectively learn disentangled representations.

Because minimizing the Wasserstein distance between the model distribution and sequential data distribution simultaneously maximizes the mutual information between input data and different disentangled latent factors, the present invention uses the loss function of a recurrent Wasserstein autoencoder to enforce the mutual information maximization for the last two terms in [symbol] _{Dis}. The present invention uses the Jensen-Shannon divergence for the penalty of the static embedding c and MMD for the penalty of the dynamic embedding. Models in accordance with the present invention can be trained in a short length of sequence and tested in the arbitrary length of sequences. The prior distribution distributions of static factor and dynamic factors are described in Equations (1) and (2).

$$𝔻 ( {Q}_{{Z}^{c}} , {P}_{{Z}^{c}} ) = {𝔻}_{JS} ( {Q}_{{Z}^{c}} , {P}_{{Z}^{c}} ) ; 𝔻 ( {Q}_{{Z}_{t}^{m} \vert {Z}_{< t}^{m}} , {P}_{{Z}_{t}^{m} \vert {Z}_{< t}^{m}} ) = {MMD}_{k} ( {Q}_{{Z}_{t}^{m} \vert {Z}_{< t}^{m}} , {P}_{{Z}_{t}^{m} \vert {Z}_{< t}^{m}} ) . \\ {MMD}_{k} ( q ( {\tilde{z}}^{c} ) , p ( {z}^{c} ) ) = \frac{1}{n ( n - 1 )} {\sum }_{i \neq j} k ( {z}_{i} , {z}_{j} ) + \frac{1}{n ( n - 1 )} {\sum }_{i \neq j} k ( {\tilde{z}}_{i} , {\tilde{z}}_{j} ) - \frac{1}{{n}^{2}} {\sum }_{i , j} k ( {\tilde{z}}_{i} , {z}_{j} ) . \\ k ( x , y ) = exp ( - \frac{{‖ x - y ‖}^{2}}{2 {σ}^{2}} ) \qquad ( 9 )$$

Each video x is encoded into content embedding c and motion embedding m. A network p_{σ}(m|c) helps disentangle motion and content embeddings. The motion embedding m and content embedding c are expected to be independent by minimizing mutual information I(m; c). A description will now be given regarding a MI sample-based upper bound, in accordance with an embodiment of the present invention.

To estimate I(m; c), a novel sample based upper bound is proposed. Assume there are M latent embedding pairs

$$\{ ( {m}_{j} , {c}_{j} ) \} \frac{M}{j = 1}$$

drawn from p(m, c). As shown in the following Theorem, an upper bound of mutual information is derived based on the samples.

Theorem: if (mⱼ, cⱼ)˜p(m, c), j=1, . . . , M,

then

$$I ( m ; c ) \leq 𝔼 [ \frac{1}{M} {\sum }_{j = 1}^{M} {R}_{j} ] = : \hat{I} ( m , c ) , where \\ {R}_{j} = log p ( {m}_{j} \vert {c}_{j} ) - \frac{1}{M} {\sum }_{k = 1}^{M} log p ( {m}_{j} \vert {c}_{k} ) . \qquad ( 10 )$$

Based on the Theorem, given embedding samples

$$\{ {m}_{j} , {c}_{j} \} \frac{M}{j = 1} , \frac{1}{M} {\sum }_{j = 1}^{M}$$

Rⱼ can be minimized as an unbiased upper bound of I(m; c). To calculate Rⱼ, the condition distribution p(m|c) is required. Two solutions are proposed to obtain the conditional distribution p(m|c): (1) using the Bayesian rule, derive the p(mic) from the variational encoder distribution p(m, c|x) and p(c|x); (2) using a neural network p_{σ}(m|c) to approximate p(m|c). In practice, the first approach is not numerically stable. Here we mainly focus on the neural network approximation.

In implementation, M videos {xⱼ} are first encoded in the encoder q_{θ}(m, cθx) to obtain the sampled embedding pairs {(m|cⱼ)}. Then the condition distribution p_{σ}(c|x) is trained by maximizing the loglikelihood

$$\frac{1}{M} {\sum }_{j = 1}^{M} log {p}_{σ} ( {m}_{j} \vert {c}_{j} ) .$$

After the training of p_{σ}((m|c) is finished, Rⱼ is calculated for each embedding pair (mⱼ, cⱼ). Finally, the gradient for

$$\frac{1}{M} {\sum }_{j = 1}^{M} {R}_{j}$$

is calculated and back-propagated to the encoder q_{θ}(m, c|x). The reparameterization trick is applied to ensure the gradient back-propagating through the sampled embeddings (mⱼ, cⱼ). When the encoder weights update, the distribution q_{θ}(m, c|x) changes, which leads to the changing of conditional distribution p(mκ). Therefore, the approximation network p_{σ}(m|c) needs to be updated again. Consequently, in the training scheme, the encoder network q_{θ}(m, c|x) and the approximation network p_{σ}(mκ) are alternatively updated.

A description will now be given regarding an encoder/decoder framework, in accordance with an embodiment of the present invention. One important downstream task for disentangled representation learning (DRL) is conditional generation. The MI-based video DRL method of the present invention can be also embedded into a Encoder-Decoder generative model and be trained in an end-to-end scheme. Since the proposed DRL encoder q_{θ}(s, c|x) is a stochastic neural network, a natural extension is adding a decoder to build a variational autoencoder with the loss [symbol] _{V AE} as described in Equation 7.

The VAE objective and the MI based disentanglement term are combined together to form an end-to-end learning framework. The total loss function is

[symbol]

= [symbol] _{V AE}+λ₁ [symbol] _{JS}+λ₂ [symbol] _{MMD}+λ₃ [symbol] _{MI}

where λ₁, λ₂ and λ₃ are balancing factors, [symbol] _{JS}= [symbol] _{JS}(Q_{Z°},P_{Z°})

[symbol]

_{MMD}=MMDₖ(Q_{Z}_{ₜ}_{^{m}}_{|Z}_{_{<t}}_{^{m}},P_{Z}_{ₜ}_{^{m}}_{|Z}_{_{<t}}_{^{m}})

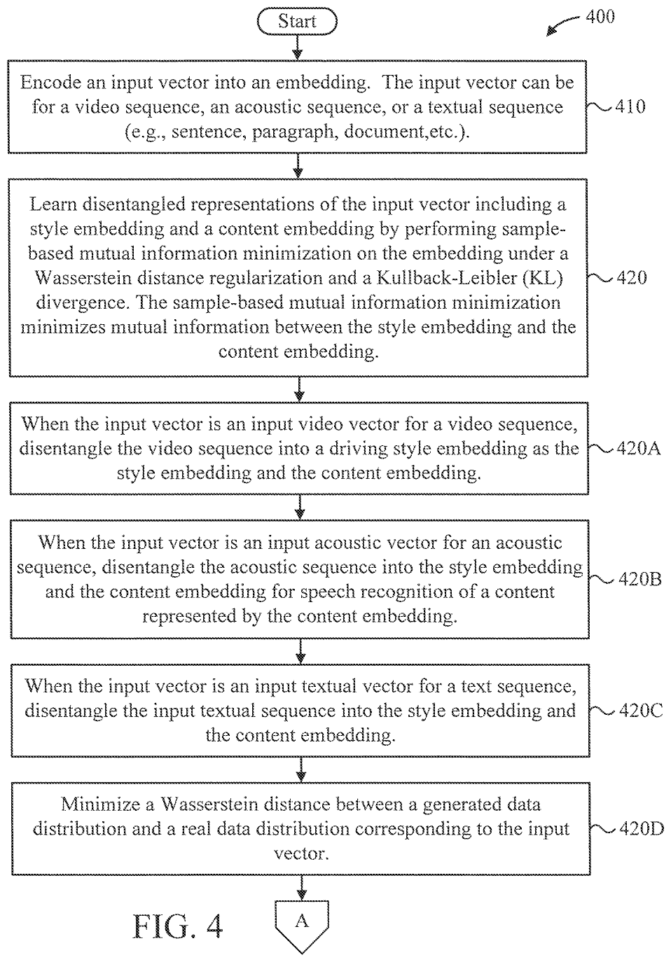

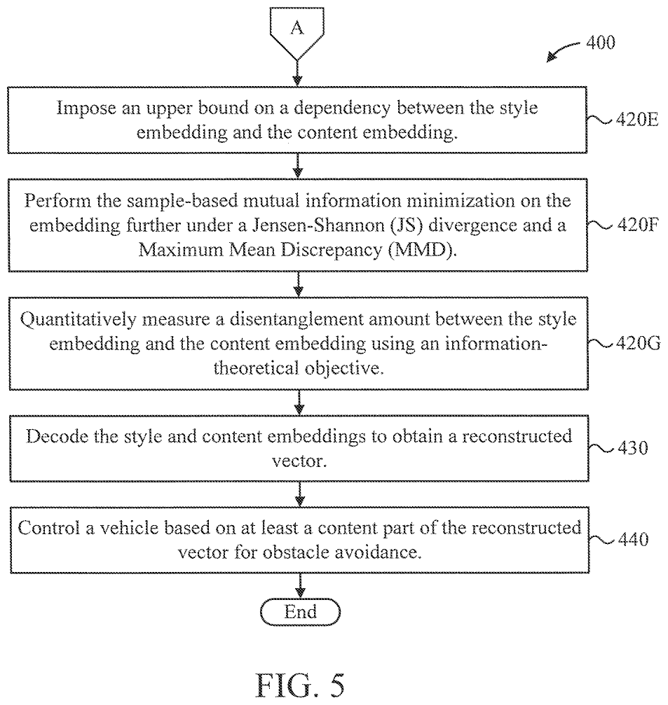

FIGS. 4-5 are block diagrams showing an exemplary method 400 for representation disentanglement, in accordance with an embodiment of the present invention.

At block 410, encode an input vector into an embedding. In an embodiment, the input vector can be for a video sequence, an acoustic sequence, or a textual sequence (e.g., sentence, paragraph, document, etc.).

At block 420, learn disentangled representations of the input vector including a style embedding and a content embedding by performing sample-based mutual information minimization on the embedding under a Wasserstein distance regularization and a Kullback-Leibler (KL) divergence. The sample-based mutual information minimization minimizes mutual information between the style embedding and the content embedding.

In an embodiment, block 420 can include one or more of blocks 420A through 420G.

At block 420A, when the input vector is an input video vector for a video sequence, disentangle the video sequence into a driving style embedding as the style embedding and the content embedding.

At block 420B, when the input vector is an input acoustic vector for an acoustic sequence, disentangle the acoustic sequence into the style embedding and the content embedding for speech recognition of a content represented by the content embedding.

At block 420C, when the input vector is an input textual vector for a text sequence, disentangle the input textual sequence into the style embedding and the content embedding.

At block 420D, minimize a Wasserstein distance between a generated data distribution and a real data distribution corresponding to the input vector.

At block 420E, impose an upper bound on a dependency between the style embedding and the content embedding.

At block 420F, perform the sample-based mutual information minimization on the embedding further under a Jensen-Shannon (JS) divergence and a Maximum Mean Discrepancy (MMD). The JS divergence is applied to a static portion of the embedding corresponding to the style embedding and the MMD is applied to a dynamic portion of the embedding corresponding to the content embedding.

At block 420G, quantitatively measure a disentanglement amount between the style embedding and the content embedding using an information-theoretical objective.

At block 430, decode the style and content embeddings to obtain a reconstructed vector.

At block 440, control a vehicle based on at least a content part of the reconstructed vector for obstacle avoidance.

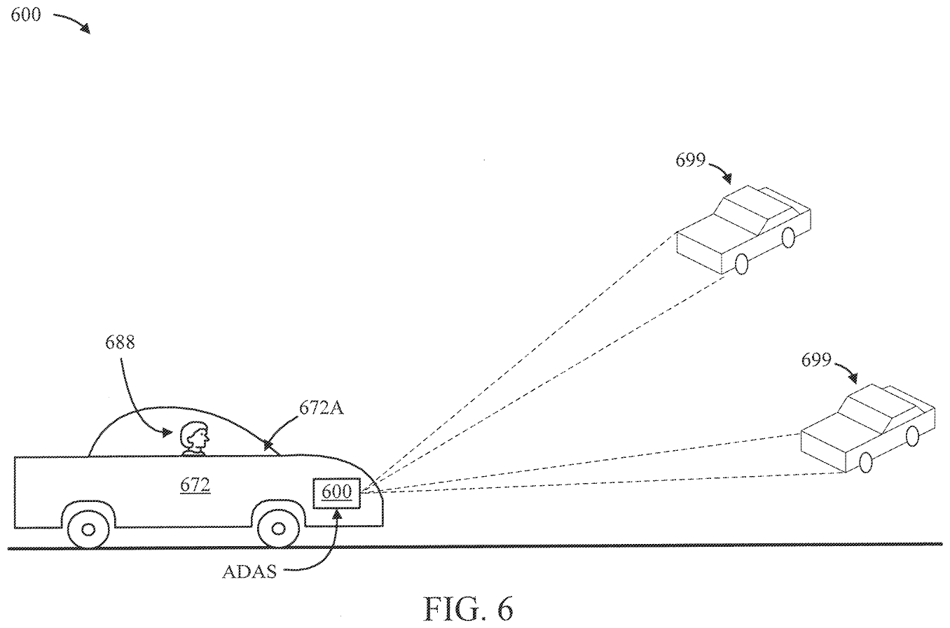

FIG. 6 is a block diagram showing an exemplary environment 600 to which the present invention can be applied, in accordance with an embodiment of the present invention.

In the environment 600, a user 688 is located in a scene with multiple objects 699, each having their own locations and trajectories. The user 688 is operating a vehicle 672 (e.g., a car, a truck, a motorcycle, etc.) having an ADAS 677.

The ADAS 677 calculates an information theory guided sequential representation disentanglement.

Responsive to a disentanglement, a vehicle controlling decision is made. To that end, the ADAS 677 can control, as an action corresponding to a decision, for example, but not limited to, steering, braking, and accelerating systems.

Thus, in an ADAS situation, steering, accelerating/braking, friction (or lack of friction), yaw rate, lighting (hazards, high beam flashing, etc.), tire pressure, turn signaling, and more can all be efficiently exploited in an optimized decision in accordance with the present invention.

The system of the present invention (e.g., system 600) may interface with the user through one or more systems of the vehicle 672 that the user is operating. For example, the system of the present invention can provide the user information through a system 672A (e.g., a display system, a speaker system, and/or some other system) of the vehicle 672. Moreover, the system of the present invention (e.g., system 600) may interface with the vehicle 672 itself (e.g., through one or more systems of the vehicle 672 including, but not limited to, a steering system, a braking system, an acceleration system, a steering system, a lighting (turn signals, headlamps) system, etc.) in order to control the vehicle and cause the vehicle 672 to perform one or more actions. In this way, the user or the vehicle 672 itself can navigate around these objects 699 to avoid potential collisions there between. The providing of information and/or the controlling of the vehicle can be considered actions that are determined in accordance with embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for representation disentanglement, comprising:
encoding an input vector into an embedding;
learning, by a hardware processor, disentangled representations of the input vector including a style embedding and a content embedding by performing sample-based mutual information minimization on the embedding under a Wasserstein distance regularization and a Kullback-Leibler (KL) divergence; and
decoding the style and content embeddings to obtain a reconstructed vector.

2. The computer-implemented method of claim 1, wherein the input vector is an input video vector for a video sequence, and said learning step comprises disentangling the video sequence into a driving style embedding as the style embedding and the content embedding.

3. The computer-implemented method of claim 2, further comprising controlling a vehicle based on at least a content part of the reconstructed vector for obstacle avoidance.

4. The computer-implemented method of claim 1, wherein the input vector is an input acoustic vector for an acoustic sequence, and said learning step comprises disentangling the acoustic sequence into the style embedding and the content embedding for speech recognition of a content represented by the content embedding.

5. The computer-implemented method of claim 1, wherein the sample-based mutual information minimization minimizes mutual information between the style embedding and the content embedding.

6. The computer-implemented method of claim 1, wherein an information-theoretical objective is used to quantitatively measure a disentanglement amount between the style embedding and the content embedding.

7. The computer-implemented method of claim 1, wherein the method is performed by an Advanced Driver Assistance System (ADAS).

8. The computer-implemented method of claim 1, wherein the sample-based mutual information minimization involves a Wasserstein distance minimization between a generated data distribution and a real data distribution corresponding to the input vector.

9. The computer-implemented method of claim 1, wherein the sample-based mutual information minimization comprises an upper bound on a dependency between the style embedding and the content embedding.

10. The computer-implemented method of claim 1, further comprising performing the sample-based mutual information minimization on the embedding further under a Jensen-Shannon (JS) divergence and a Maximum Mean Discrepancy (MMD).

11. The computer-implemented method of claim 10, wherein the JS divergence is applied to a static portion of the embedding corresponding to the content embedding and the MMD is applied to a dynamic portion of the embedding corresponding to the motion embedding.

12. A computer program product for representation disentanglement, the computer program product comprising a non-transitory computer readable storage medium having program instructions embodied therewith, the program instructions executable by a computer to cause the computer to perform a method comprising:
encoding, by a hardware processor of the computer, an input vector into an embedding;
learning, by the hardware processor, disentangled representations of the input vector including a style embedding and a content embedding by performing sample-based mutual information minimization on the embedding under a Wasserstein distance regularization and a Kullback-Leibler (KL) divergence; and
decoding, by the hardware processor, the style and content embeddings to obtain a reconstructed vector.

13. The computer program product of claim 12, wherein the input vector is an input video vector for a video sequence, and said learning step comprises disentangling the video sequence into a driving style embedding as the style embedding and the content embedding.

14. The computer program product of claim 13, further comprising controlling a vehicle based on at least a content part of the reconstructed vector for obstacle avoidance.

15. The computer program product of claim 12, wherein the input vector is an input acoustic vector for an acoustic sequence, and said learning step comprises disentangling the acoustic sequence into the style embedding and the content embedding for speech recognition of a content represented by the content embedding.

16. The computer program product of claim 12, wherein the sample-based mutual information minimization minimizes mutual information between the style embedding and the content embedding.

17. The computer program product of claim 12, wherein an information-theoretical objective is used to quantitatively measure a disentanglement amount between the style embedding and the content embedding.

18. The computer program product of claim 12, wherein the method is performed by an Advanced Driver Assistance System (ADAS).

19. The computer program product of claim 12, wherein the sample-based mutual information minimization involves a Wasserstein distance minimization between a generated data distribution and a real data distribution corresponding to the input vector.

20. A computer processing system for representation disentanglement, comprising:
a memory device for storing program code; and
a processor device, operatively coupled to the memory device, for running the program code to:
encode an input vector into an embedding;
learn disentangled representations of the input vector including a style embedding and a content embedding by performing sample-based mutual information minimization on the embedding under a Wasserstein distance regularization and a Kullback-Leibler (KL) divergence; and
decode the style and content embeddings to obtain a reconstructed vector.
